(19) United States
(12) Patent Application Publication
(10) Pub. No.: US 2018/0295865 A1
(43) Pub. Date: Oct. 18, 2018

(54) Apparatus for Cooking Popcorn and Method of Controlling the Same

(71) Applicant: Daewoo Electronics Co., Ltd., Seoul (KR)

(72) Inventors: Jeong Hee PARK, Incheon (KR); Won Yong CHAE, Incheon (KR); Seong Ok KIM, Incheon (KR); Eun Young LEE, Incheon (KR)

(21) Appl. No.: 15/951,581

(22) Filed: Apr. 12, 2018

(30) Foreign Application Priority Data
Apr. 13, 2017 (KR) 10-2017-0047913

(51) Int. Cl. A23L 7/187; H05B 6/68

(52) U.S. Cl. CPC A23L 7/187; H05B 6/687

(57) ABSTRACT

A cooking apparatus may include a main body forming an outward appearance of the oven and having with a cooking room within the main body, a door on one side of the main body configured to selectively open and close the cooking room, a manipulation unit in and/or on an external surface of the main body, configured to enable a user to input a popcorn cooking command, a display displaying a cooking state according to the popcorn cooking command, a driving unit configured to heat a plurality of corn grains in the cooking room, a memory storing a popcorn cooking algorithm adapted to control the driving unit to cook the popcorn, and a control unit controlling the driving unit in response to the popcorn cooking algorithm. The control unit consecutively or continuously drives the driving unit for a first set time, intermittently drives the driving unit for a second set time after the first set time, and consecutively or continuously drives the driving unit for a third set time after the second set time.

### TECHNICAL FIELD

The present disclosure relates to an apparatus for cooking or popping popcorn and a method of controlling the same.

### BACKGROUND

A cooking apparatus is a home appliance that is located in a kitchen space and is used to cook food. Cooking apparatuses can be classified into a microwave oven, a resistance oven, and a gas oven, depending on the heat source for heating the food, and further into a built-in type, a stand-alone type and a wall-mount type, depending on the installation type.

The microwave oven is a kitchen device for cooking food in such a way as to heat the food by applying microwaves to an internal space in the oven where the food is located. The resistance oven and the gas oven are kitchen devices for cooking food by heat generated from a heater or burner to an internal space in the oven where the food is located.

In general, the cooking apparatus may include a main body forming an outward appearance, a cavity (that is, the space where the food is cooked) within the main body, an electronic room housing or including a plurality of electronic parts for cooking food on one side of the cavity, and a heat source for heating food within the cavity.

The heat source may include a magnetron that generates the microwaves for heating food, or a heater or burner that radiates heat for heating food.

The cooking apparatus can cook popcorn. Popcorn is corn that has been popped. Specifically, when corn grains are heated, moisture within the corn is confined due to the corn's hard shell, and thus internal pressure within the shell rises. When the internal pressure within the shell rises to a specific pressure or more, the corn suddenly expands, pops and/or billows to a volume several times the original volume. Corn in this state is called popcorn.

Popcorn is cooked through a process in which the state of the corn changes suddenly and in a complicated manner, as described above. Popcorn is rarely cooked by simple heating, that is, a simple method using a common cooking apparatus. For example, if corn grains are put into a cooking apparatus, such as a microwave, and are simply heated, when the corn grains are cooked until they are not burnt, there are problems in that many grains that have not been popped, and the total volume of popcorn is small because the number of popped corn grains is small. Furthermore, if corn grains are cooked until they are burnt, the number of popped corn grains may be greater, but there are problems in that many corn grains are burnt and are not good enough to eat, and the resulting total volume of popcorn is also small.

### PRIOR ART DOCUMENT

### Patent Document

Patent Document 1: Korean Patent Application Publication No. 10-2013-0120840 (Nov. 5, 2013)

### SUMMARY

Embodiments of the present disclosure provide an apparatus for cooking popcorn that can reduce unpopped corn grains while properly cooking corn grains, and a method of controlling the same.

Furthermore, embodiments of the present disclosure provide an apparatus for cooking popcorn that can increase the volume of popcorn formed (e.g., from a given volume of unpopped grains), and a method of controlling the same.

In accordance with an aspect of the present invention, there may be provided an apparatus for cooking popcorn, including a main body configured to form an outward appearance and equipped with a cooking room within the main body, a door on one side of the main body to selectively open or shut the cooking room, a manipulation unit in and/or on the external surface of the main body, configured to enable a user to input a popcorn cooking command, a display configured to display a cooking state according to the popcorn cooking command, a driving unit configured to apply heat to a plurality of corn grains in the cooking room, a memory configured to store a popcorn cooking algorithm adapted to control the driving unit to cook the popcorn, and a control unit configured to control an operation of the driving unit in response to the popcorn cooking algorithm, wherein the control unit is configured to increase a temperature of moisture included in the corn grains by consecutively or continuously driving the driving unit for a first set time, intermittently driving the driving unit for a second set time after the first set time, and pop the corn grains by consecutively or continuously driving the driving unit for a third set time after the second set time. Intermittently driving the driving unit may preheat the corn grains

Furthermore, the control unit may stop the operation of the driving unit for a fourth set time after the third set time, and pop unpopped corn grains using remaining heat in the cooking room.

Furthermore, the control unit may control driving the driving unit based on a predetermined and/or constant pattern for the second set time. In one example, the control unit may control driving the driving unit by determining whether or not to drive the driving unit (e.g., by turning the driving unit on or off).

Furthermore, in the intermittent driving time of the driving unit during the second set time, a heating time may be shorter than a pause time.

Furthermore, the driving unit may be driven with a constant output for the first set time and the third set time.

In accordance with another aspect of the present invention, there may be provided a method for controlling an apparatus for cooking popcorn, including receiving a cooking command from a manipulation unit in a main body of the apparatus, determining whether the cooking command is a popcorn cooking command, or continuously driving a driving unit for a first set time when it is determined that the cooking command is the popcorn cooking command, then intermittently driving the driving unit at preset intervals for a second set time, and then driving the driving unit for a third set time. Driving the driving unit for the first set time may perform a first cooking operation on a plurality of corn grains in a cooking room of the main body. Driving the driving unit intermittently for the second set time may perform a second cooking operation. Driving the driving unit for the third set time may perform a third cooking operation.

Furthermore, the second set time may be set so that a temperature within the corn grains is to 150 to 175° C.

Furthermore, during the second set time, the driving unit may be driven in a constant or repetitive pattern.

Furthermore, when the driving unit is intermittently driven for the second set time, a heating time may be shorter than a pause time.

Furthermore, the driving unit may be driven with constant output for the first set time, the second set time, and the third set time.

Furthermore, the method may further include pausing an operation of the driving unit for a fourth set time after the third set time. Pausing the operation of the driving unit may be referred to as a “pause step.”

Furthermore, the corn grains may be popped during the third set time, after the corn grains are preheated during the second set time.

In accordance with another aspect of the present invention, there is provided a method for controlling an apparatus for cooking popcorn, including receiving a popcorn cooking command from a manipulation unit in a main body of the apparatus, increasing a temperature of moisture in a plurality of corn grains in a cooking room using a control unit to consecutively or continuously drive a driving unit to heat the corn grains for a first set time, intermittently driving the driving unit using the control unit for a second set time after the first set time, consecutively or continuously driving the driving unit using the control unit for a third set time after the second set time to pop at least some of the corn grains, and stopping an operation of the driving unit using the control unit after the third set time and popping unpopped corn grains using remaining heat within the cooking room. The driving unit may be stopped for a fourth set time.

Furthermore, an output (e.g., a power) of the driving unit may be 1000 W, the first set time may be 28 seconds, the second set time may be 62 seconds, the third set time may be 75 seconds, and the fourth set time may be 5 seconds. In the second set time, the driving unit may repeat 12 times a 2-second driving operation and a 3-second pause, then pause for an additional 2 seconds. The output of the driving unit may have a rated high frequency.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view schematically showing an outward appearance of an apparatus for cooking popcorn according to an embodiment of the present disclosure.

FIG. 2 is a block diagram showing a configuration of the cooking apparatus of FIG. 1.

FIG. 3 is a flowchart showing a method for controlling the apparatus for cooking popcorn according to an embodiment of the present disclosure.

FIG. 4 is a graph showing an example of an operation of the driving unit in the method of FIG. 3.

### DETAILED DESCRIPTION

Hereinafter, specific embodiments of the present disclosure will be described in detail with reference to the drawings.

In addition, in the description of the present disclosure, the detailed description of known functions and configurations incorporated herein will be omitted if they would unnecessarily obscure features of the subject matter of the present disclosure.

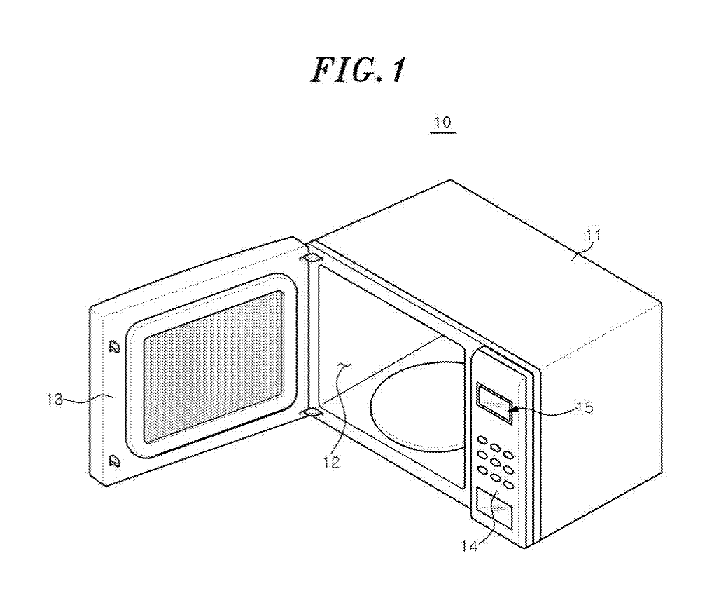

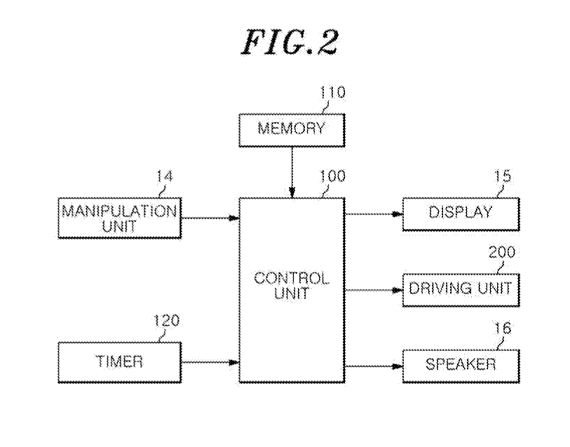

FIG. 1 is a perspective view schematically showing an outward appearance of an apparatus for cooking popcorn according to an embodiment of the present disclosure. FIG. 2 is a block diagram showing a configuration of the cooking apparatus of FIG. 1.

Referring to FIGS. 1 and 2, the cooking apparatus 1 according to an embodiment of the present disclosure cooks food by heating using a heat source and will be illustrated with a microwave oven. However, the spirit of the present disclosure is not limited to the microwave oven and may be applied to various cooking apparatuses, such as a resistive or gas oven.

Specifically, the cooking apparatus 1 may include a main body 11 forming an outward appearance of the oven and having a cooking room 12 therein, a door 13 on one side of the main body 11 to selectively open and close the cooking room 12, a manipulation unit 14 in and/or on the external surface of the main body 11 and equipped with buttons capable of selecting a cooking type, a cooking method, and a cooking time by a user and the start and end (e.g., stopping) of a cooking operation, and a display 15 capable of displaying information about food selected by a user and a state of the cooking operation. Furthermore, the cooking apparatus 1 may further include a speaker 16 for transferring information to the user through sound.

Furthermore, the cooking apparatus 1 may include a control unit 100 having a program adapted to drive the cooking apparatus 1 installed therein, and outputting various types of operations and/r control signals for operations, a memory 110 storing an algorithm and optionally data for the algorithm to operate the apparatus 1 according to a cooking type, a recipe and/or a function, a timer 120 configured to set a time length for an operation and/or count an elapsed time, and a driving unit 200 configured to heat a cooking target in response to a control signal from the control unit 100.

A user may select a specific recipe from various recipes stored in the memory 110 and/or specific functions and/or conditions for cooking using the manipulation unit 14. In one or more embodiments, the specific recipe is for popcorn. That is, the user may input a popcorn cooking command through the manipulation unit 14. The display 15 may display a cooking state according to the popcorn cooking command. A cooking target may be a plurality of corn grains. For example, the control unit 100 may display a list of recipes that may be selected on the display 15 in response to a user's manipulation. The user may select “popcorn” from the list displayed on the display 15 using a button in the manipulation unit 14. A separate button to initiate popcorn cooking may be in the manipulation unit 14.

The memory 120 may store detailed recipes, for example, recipe algorithms including intensities of heating, heating times, and heating intervals. In particular, in one embodiment, a popcorn cooking algorithm may be stored in the memory 120. In this case, the recipe algorithm may comprise a series of processes of controlling the driving unit 200 in order to cook a target recipe, and may include information, such as the operating time, interval and heating intensity of the driving unit 200, in a time-series manner. In response to a user's selection, the control unit 100 may load the popcorn cooking algorithm from the memory 120 and control the driving unit 14 based on elapsed time information from the timer 17.

The driving unit 200 is on one side or around the circumference of the cooking room 12, and may transmit microwaves into the cooking room 12 and adjust the intensity of the microwaves under the control of the control unit 100. In one embodiment, the driving unit 200 of the cooking apparatus 1 has been illustrated as generating microwaves, but the spirit of the present disclosure is not limited thereto. For example, the driving unit 200 may be a device capable of heating a cooking target using radiant heat or a convection current.

The control unit 100 may notify a user of a progress state of a cooking operation, an elapsed time of cooking, and/or whether cooking has been completed or not using the display 15 or the speaker 16 while a recipe is implemented by the driving unit 200.

The cooking apparatus 1 configured as described above according to an embodiment of the present disclosure may cook popcorn in response to a user's selection.

A method of cooking popcorn using the cooking apparatus 1 is described in detail below with reference to the drawings.

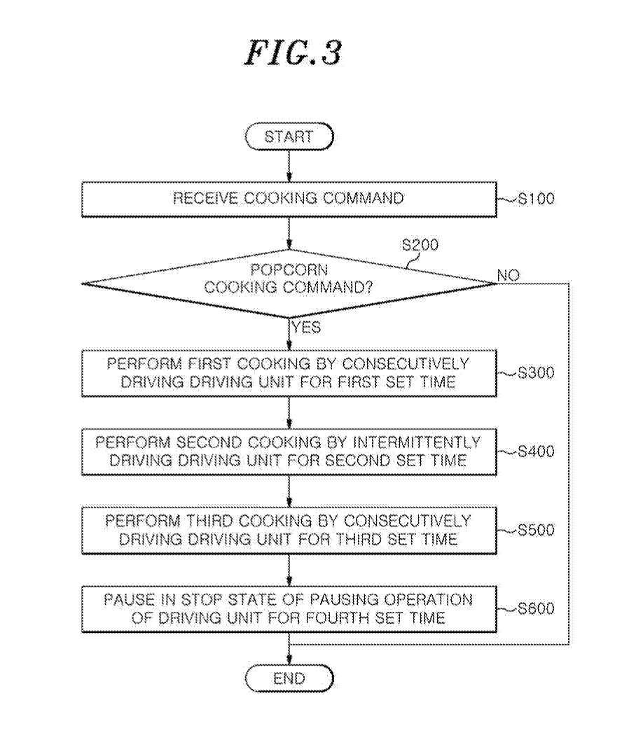

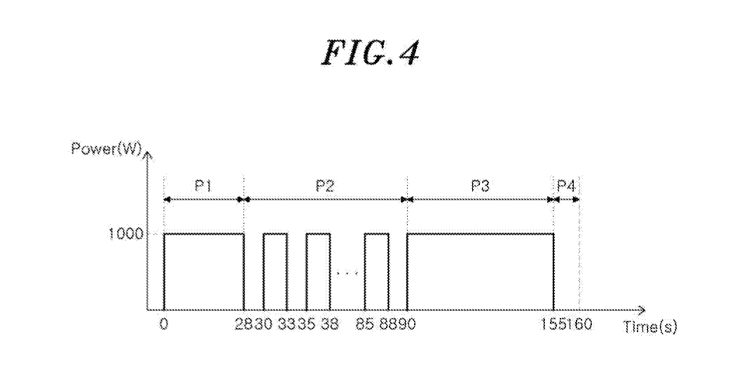

FIG. 3 is a flowchart showing a method for controlling the apparatus for cooking popcorn according to an embodiment of the present disclosure. FIG. 4 is a graph showing an example of an operation of the driving unit in the method of FIG. 3.

Referring to FIGS. 3 and 4, the method of controlling the apparatus 1 for cooking popcorn according to an embodiment of the present disclosure may correspond to the popcorn cooking algorithm stored in the memory 110, and includes receiving a cooking command from a user (S100). The user may input a command for cooking desired food using the manipulation unit 14.

The control unit 100 determines whether the food selected by the manipulation unit 14 is popcorn (S200). When the user selects popcorn cooking, the control unit 100 starts cooking the popcorn according to the popcorn cooking algorithm to be described later. In this case, the popcorn cooking algorithm may have been stored in the memory 120. A different value may have been set in the popcorn cooking algorithm for each cooking apparatus 1, depending on output of the driving unit 200 and the size of the cooking room 12. Furthermore, the popcorn cooking algorithm may have a different set value depending on the size, amount and type of corn grains to be cooked. The user may set the size, amount and type of popcorn using the manipulation unit 14.

When the user selects a popcorn cooking command, the control unit 100 performs a first cooking process P1 by consecutively or continuously driving the driving unit 200 for a first set time (S300). In the first cooking process P1, a temperature of the moisture in the corn grains is slowly increased. In this case, the control unit 100 may consecutively or continuously drive the driving unit 200 with a constant output (e.g., in which the driving unit 200 has maximum output). For example, in the case of a microwave oven in which the driving unit 200 has an output or output power of 1000 W, the first set time may be 20-35 seconds, or any range or value therein, such as 28 seconds. Furthermore, in the present description, time values for certain microwave oven operations is determined using a microwave oven in which the driving unit 200 has a rated high frequency output of 1000 W as an example.

For a second set time after the first set time, the control unit 100 performs a second cooking process P2 by intermittently driving the driving unit 200 (S400). In the second cooking process P2, at least some (e.g., more than half, 60% or more, 70% or more, etc.) of the corn grains heated in the first cooking process P1 are further heated to a temperature just below the popping temperature of the corn grains (e.g., in the range of from 150-180° C., or any value or range of values therein). The intermittent driving time of the driving unit 200 may have been previously set and stored in the memory 110, and may include the repetition of a constant on/off pattern or cycle. For example, the control unit 100 may repeatedly drive the driving unit 200 with a constant (e.g., maximum) output. In the intermittent driving time of the driving unit 200 in the second cooking process P2, the heating time ON may be shorter than the pause time OFF. Accordingly, a temperature distribution within the corn grains can become relatively uniform because the temperature within the corn grains sufficiently absorbing the microwaves rises during the heating time and is transferred to corn grains sufficiently absorbing the microwaves during the pause time. As a result, in a subsequent cooking process, most or all of the corn grains can be popped up around the same time. For example, the control unit 100 may repeatedly drive the driving unit 200 in cycles comprising or consisting of a 2-second ON state and a 3-second OFF state. After repeating such a process/cycle 12 times (60 seconds), the control unit 100 may stop the heating for 1-5 seconds (or any value or range of values therein, such as 2 seconds) by turning off the driving unit 200 and waiting for a next cooking process. In this case, the second set time (that is, the progress time of the second cooking process P2) may be set so that a temperature of the corn grains rises and reaches a temperature just below the opposing temperature of the corn. For example, the popping temperature of common corn grains for popcorn is about 175-180° C. A time interval for the second set time and intermittent driving may be set so that the temperature within the corn becomes 170-175° C.

After the second cooking process P2 is completed that is, after the second set time elapses), the control unit 100 performs a third cooking process P3 of consecutively or continuously driving the driving unit 200 for a third set time (S500) to pop the corn grains. In this case, the driving unit 200 may be driven at a specific maximum output. In the second cooking process P2, the corn grains have been heated to a temperature right before the corn grains pop. Accordingly, the corn is popped to become popcorn as the third cooking process P3 is performed. In one embodiment, the third set time may be 75 seconds.

Finally, for a fourth set time, the control unit 100 stops the operation of the driving unit 200 and performs a fourth cooking process P4 of performing additional popping using heat remaining within the cooking room 12, the heat in the corn grains, and the heat of the tray (S500). In the fourth cooking process P4, the popcorn is not burnt and an additional popping occurs even though vibration heating by the microwaves is not occurring. Furthermore, in the fourth cooking process P4, the temperature within the cooking room 12 drops. Accordingly, safety accidents attributable to heat that may occur when the door 13 is opened can be prevented. The fourth cooking process P4 may be performed for 2-30 seconds, or any value or range of values therein (e.g., 5 seconds).

In accordance with one embodiment, in the case of a microwave oven having a 1000 W rating, a popcorn cooking process may be performed for a total of 2 minutes and 40 seconds (160 seconds). The first set time, second set time, preset time interval (e.g., the additional pause time in the second set time), third set time, and fourth set time for the popcorn cooking process may be stored in the memory 120 as variable values of the popcorn cooking algorithm.

In one embodiment, the control unit 100 is illustrated as driving the driving unit 200 with maximum output in each cooking process, but the spirit of the present disclosure is not limited thereto. For example, the control unit 100 may provide a different output power to the driving unit 200 in each process, and may change the output power of the driving unit 200 depending on the cooking time even in a single process or operation.

In accordance with the apparatus 1 for cooking popcorn and the method of controlling the same according to embodiments of the present disclosure, there is an effect in that the formation volume of popcorn can be increased because a higher proportion of corn grains can be sufficiently popped. Specifically, corn grains are heated up to just below a popping temperature in the second cooking process P2 (prior to the third cooking process P3 of popping the corn grains), and the temperature within the corn grains may become relatively uniform. Accordingly, a large number of corn grains can be popped during the third cooking process P3. Accordingly, the number of corn grains that have not been popped can be reduced, and the final volume of popcorn can be increased.

Furthermore, the problem in that corn grains that are previously popped, excessively heated and burnt can be prevented because popping occurs intensively during the third cooking process P3 (after the corn grains are heated in the second process P2).

Furthermore, burnt popcorn can be minimized because unpopped corn grains are popped by heat remaining within the cooking room 12 (i.e., without vibrational or additional oscillating heating) during the fourth cooking process P4.

Table 1 shows average values obtained when corn grains were cooked using a driving unit at maximum output during a cooking process (110 seconds or 105 seconds) in a conventional cooking apparatus having an output of 1000 W.

TABLE 1

| | | Number of | |
|---|---|---|---|
| | | unpopped corn | |
| Cooking time | Final volume | grains remaining | Popcorn quality |
| 110 seconds | 2400 ml | 28 | A lot of burnt popcorn |
| 105 seconds | 2350 ml | 42 | Appropriate |

Furthermore, Table 2 shows average values obtained when the same number of corn grains as in the examples of Table 1 were cooked using the cooking apparatus with the driving unit at the maximum output of 1000 W according to an embodiment of the present disclosure.

TABLE 2

| | | Number of | |
|---|---|---|---|
| | | unpopped corn | |
| Cooking time | Final volume | grains remaining | Popcorn quality |
| 240 seconds | 2800 ml | 15 | Appropriate |

As may be seen from Table 1 and Table 2, in the case of the cooking apparatus 1 according to the present disclosure, although the total cooking time was increased, the final volume of popcorn was increased about 15%, the remaining number of corn grains was reduced about 50%, and the popcorn was not burnt.

The following is a list of various embodiments of the present disclosure.

A first embodiment includes an apparatus for cooking popcorn, including a main body configured to form an outward appearance and having a cooking room in the main body, a door on one side of the main body to selectively open and close the cooking room, a manipulation unit in and/or on the external surface of the main body, configured to enable a user to input a popcorn cooking command, a display configured to display a cooking state according to the popcorn cooking command, a driving unit configured to heat a plurality of corn grains in the cooking room, a memory configured to store a popcorn cooking algorithm adapted to control the driving unit to cook the popcorn, and a control unit configured to control an operation of the driving unit in response to the popcorn cooking algorithm, wherein the control unit is configured to increase a temperature of moisture in the corn grains by consecutively or continuously driving the driving unit for a first set time, intermittently drive the driving unit for a second set time after the first set time, and consecutively or continuously drive the driving unit for a third set time after the second set time.

A second embodiment includes the apparatus for cooking popcorn according to the first embodiment, wherein the control unit stops the operation of the driving unit for a fourth set time after the third set time and pops unpopped corn grains by heat remaining within the cooking room.

A third embodiment includes the apparatus for cooking popcorn according to the first and/or second embodiments, wherein the control unit controls driving the driving unit based on a predetermined and/or constant pattern for the second set time.

A fourth embodiment includes the apparatus for cooking popcorn according to the first through third embodiments, wherein in the second set time, a heating time is shorter than a pause time.

A fifth embodiment includes the apparatus for cooking popcorn according to the first through fourth embodiments, wherein the driving unit is driven with constant output for the first set time and the third set time.

A sixth embodiment includes a method for controlling an apparatus for cooking popcorn according to the first through fifth embodiments, including receiving a cooking command through a manipulation unit in and/or on a main body of the cooking apparatus, determining whether the received cooking command is a popcorn cooking command, consecutively or continuously driving a driving unit for a first set time when it is determined that the cooking command is the popcorn cooking command, intermittently driving the driving unit at preset intervals for a second set time after the first set time, and consecutively or continuously driving the driving unit for a third set time after the second set time.

A seventh embodiment includes the method for controlling an apparatus for cooking popcorn according to the first through sixth embodiments, wherein the second set time is set so that a temperature within the corn grains is from 150 to 175° C.

An eighth embodiment includes the method for controlling an apparatus for cooking popcorn according to the first through seventh embodiments, wherein during the second set time, the driving unit is driven in a constant pattern.

A ninth embodiment includes the method for controlling an apparatus for cooking popcorn according to the first through eighth embodiments, wherein during the second set time, a heating time is shorter than a pause time.

A tenth embodiment includes the method for controlling an apparatus for cooking popcorn according to the first through ninth embodiments, wherein the driving unit is driven with constant output for at least the first set time and the third set time.

An eleventh embodiment is the method for controlling an apparatus for cooking popcorn according to the first through tenth embodiments, further including pausing an operation of the driving unit for a fourth set time after the third set time.

A twelfth embodiment includes the method for controlling an apparatus for cooking popcorn according to the first through eleventh embodiments, further comprising popping the corn grains during the third set time.

A thirteenth embodiment includes a method for controlling an apparatus for cooking popcorn according to the first through twelfth embodiments, including receiving a popcorn cooking command from a manipulation unit in and/or on a main body of the cooking apparatus, increasing a temperature of moisture in a plurality of corn grains in a cooking room using a control unit to consecutively or continuously drive a driving unit for heating the corn grains for a first set time, intermittently driving the driving unit using the control unit for a second set time after the first set time, consecutively or continuously driving the driving unit using the control unit for a third set time after the second set time, stopping an operation of the driving unit for a fourth set time after the third set time, and popping unpopped corn grains using remaining heat within the cooking room.

A fourteenth embodiment includes the method for controlling an apparatus for cooking popcorn according to first through thirteenth embodiments, wherein an output of the driving unit is 1000 W, the first set time is 28 seconds, the second set time is 62 seconds, wherein the second set time comprises (i) 12 cycles including a 2-second driving operation and 3-second pause and (ii) a 2 second pause, the third set time is 75 seconds, and the fourth set time is 5 seconds.

In accordance with the apparatus for cooking popcorn and the method of controlling the same according to embodiments of the present disclosure, there are advantages in that corn grains can be properly popped without being burnt and the number of unpopped corn grains can be reduced.

Furthermore, the volume of popped popcorn can be increased.

Although the apparatus for cooking popcorn and the method of controlling the same according to embodiments of the present disclosure have been described, the above description is merely illustrative of the technical idea of the present disclosure, and various changes and modifications may be made without departing from the essential characteristics of the present disclosure. Therefore, embodiments described in the present disclosure are not intended to limit the scope of the present disclosure, but are intended to illustrate and not limit the scope of the present disclosure. The scope of protection of the present disclosure should be construed according to the following claims, and all technical ideas that are equivalent or equivalent thereto should be interpreted as being included in the scope of the present disclosure.

What is claimed is:

1. An apparatus for cooking popcorn, comprising:
a main body configured to form an outward appearance and having a cooking room therein;
a door on one side of the main body, configured to selectively open and close the cooking room;
a manipulation unit in and/or on an external surface of the main body, configured to enable a user to input a popcorn cooking command;
a display configured to display a cooking state according to the popcorn cooking command;
a driving unit configured to heat a plurality of corn grains in the cooking room;
a memory configured to store a popcorn cooking algorithm adapted to control the driving unit to cook the popcorn; and
a control unit configured to control an operation of the driving unit in response to the popcorn cooking algorithm,
wherein the control unit is configured to:
increase a temperature of moisture in the corn grains by consecutively or continuously driving the driving unit for a first set time,
intermittently drive the driving unit for a second set time after the first set time, and
consecutively or continuously drive the driving unit for a third set time after the second set time.

2. The cooking apparatus of claim 1, wherein the control unit is further configured stop the driving unit for a fourth set time after the third set time.

3. The cooking apparatus of claim 1, wherein the control unit controls driving the driving unit based on a predetermined and/or constant pattern for the second set time.

4. The cooking apparatus of claim 3, wherein, during the second set time, a heating time is shorter than a pause time.

5. The cooking apparatus of claim 1, wherein the driving unit is driven with a constant output for the first set time and the third set time.

6. A method for controlling an apparatus for cooking popcorn, comprising:
receiving a cooking command from a manipulation unit in a main body of the cooking apparatus;
determining whether the received cooking command is a popcorn cooking command;
consecutively or continuously driving a driving unit for a first set time when it is determined that the cooking command is the popcorn cooking command; then
intermittently driving the driving unit at preset intervals for a second set time; and then
consecutively or continuously driving the driving unit for a third set time.

7. The method of claim 6, wherein the second set time is set so that a temperature within the corn grains is to 150-175° C.

8. The method of claim 6, wherein, during the second set time, the driving unit is driven in a constant or repetitive pattern.

9. The method of claim 8, wherein when the driving unit is intermittently driven for the second set time, a heating time is shorter than a pause time.

10. The method of claim 6, wherein the driving unit is driven with constant output for at least the first set time and the third set time.

11. The method of claim 6, further comprising pausing an operation of the driving unit for a fourth set time after the third set time.

12. The method of claim 6, comprising popping the corn grains during the third set time.

13. A method for controlling an apparatus for cooking popcorn, comprising:
receiving a popcorn cooking command from a manipulation unit in a main body of the cooking apparatus;
increasing a temperature of moisture in a plurality of corn grains in a cooking room using a control unit to consecutively or continuously drive a driving unit for a first set time;
intermittently driving the driving unit using the control unit for a second set time after the first set time;
consecutively or continuously driving the driving unit using the control unit for a third set time after the second set time;
stopping an operation of the driving unit for a fourth set time after the third set time; and
popping unpopped corn grains using remaining heat within the cooking room.

14. The method of claim 13, wherein:
an output of the driving unit is 1000 W,
the first set time is 28 seconds,
the second set time comprises 12 cycles of a 2-second driving operation and 3-second pause, then an additional pause for 2 seconds,
the third set time is 75 seconds, and
the fourth set time is 5 seconds.
